(19) United States
(12) Patent Application Publication
(10) Pub. No.: US 2025/0141022 A1
(43) Pub. Date: May 1, 2025

(54) BATTERY

(71) Applicant: ACELERON LIMITED, Birmingham West Midlands (GB)

(72) Inventors: Carlton CUMMINS, Birmingham (GB); Amrit CHANDAN, Birmingham, West Midlands (GB)

(21) Appl. No.: 18/726,024

(22) PCT Filed: May 5, 2022
(86) PCT No.: PCT/GB2022/051145

§ 371 Date: Jul. 1, 2024

(30) Foreign Application Priority Data
May 5, 2021 (GB) 2106414.2

(51) Int. Cl. H01M 50/262; H01M 10/42; H01M 10/54; H01M 50/213; H01M 50/293

(52) U.S. Cl. CPC H01M 50/262; H01M 10/425; H01M 50/213; H01M 50/293; H01M 2010/4271; H01M 10/54

(57) ABSTRACT

A battery pack assembly (100), the assembly (100) comprises: a plurality of cells (102a, 102b), each cell (102a, 102b) having a body portion extending between a first end having a first terminal and a second end having a second terminal, a first holding frame (101a) being configured to accommodate at least the first end of one or more of the plurality of cells (102a, 102b) and a second holding frame (101b) being configured to accommodate at least the second end of one or more of the plurality of cells (102a, 102b), an electrical control unit (103) configured to control the electrical output of the battery pack assembly (100), and a separator plate (104), wherein the separator plate (104) is located between the plurality of cells (102a, 102b) and the electrical control unit (103) and is secured to the first holding frame (101a) and the second holding frame (101b).

This invention relates generally to a battery and to a battery pack assembly. More specifically, although not exclusively, this invention relates to a battery and a battery pack assembly comprising components with better accessibility for maintenance and repair, for example, a lithium-ion battery pack assembly e.g. a large format battery pack assembly, and uses of the same.

Lithium-ion batteries are known in a variety of cell formats, wherein cylindrical, prismatic and pouch cells are the most common varieties. In a cylindrical cell the electrode is tightly wound about itself and the terminals are typically found at either end of the cylinder, the electrode being contained within a casing, typically made from aluminium or steel. Due to the shape of the cell, packing efficiency may be low but the provision of spaces between adjacent cells is useful for thermal management purposes. The electrodes of prismatic cells can be wound, stacked or folded and are usually located within an aluminium or plastics housing. The terminals are often on one end of the cell which, coupled with the shape of the cell improves packing efficiency. Pouch cells typically have stacked or folded electrodes encased in a flexible plastics casing. The terminals of pouch cells may extend from different sides of the pouch but conveniently they may both extend from one side, for example the top, of the pouch.

It is known to connect lithium-ion batteries or cells in series and/or parallel to increase the voltage to produce a “large format battery pack”. These offer several benefits including high energy density in comparison to their weight, high operating voltage and slow self-discharge. Consequently, large format battery packs of this type find use in a range of both consumer and industrial applications including as emergency power back-up, vehicle power, and solar power storage.

There appears to be no set definition of what constitutes a “large format battery pack”. The UN, for example (e.g. in relation to the UN38.3 Procedure), states that a ‘large battery’ is one that has a mass in excess of 12 kg whereas some manufacturers specify that large batteries or large format battery packs have an energy storage in excess of 1 kWh. For the purposes of this invention we consider that a large format battery pack is one with more than three cells (be they cylindrical, prismatic or pouch) connected in series and in some cases have more than 6, 9 or 12 connected cells.

Large format battery packs using cylindrical cells often have a plurality of cells, typically 15 or more cells, electrically connected and presented as a single unit called a battery module. In industry, these modules are typically assembled using permanent assembly techniques (structural adhesives, spot welding, soldering etc.). Such permanent assembly techniques present challenges for repairing or reusing the modules (or the cells or other parts thereof), as the individual components of the assembly cannot easily be accessed or removed. This also makes it difficult to recycle the modules, as the various materials cannot easily be separated.

Accordingly, such production techniques can lead to energy storage products which are not aligned with EU waste management legislations and prohibits greater revenue opportunities in the repair and repurposing of batteries and battery modules.

In our earlier patent application WO2020/128532, we describe a battery pack assembly that aims to solve this problem. The battery pack assembly comprises a first and second holding frame, a plurality of cells having terminals at each end thereof, fastening means for reversibly holding the first and second holding frames with respect to one another in a closed condition, an electrically conductive conductor plate for providing electrical contact to at least two of said plurality of cells, the conductor plate having respective protrusions for making contact with each of said at least two cells, the first holding frame bearing directly against said conductor plate to cause the protrusions of the conductor plate to make electrical contact with said at least two cells in said closed condition.

In our earlier patent application WO2020/128533, we describe another battery pack assembly that aims to solve the aforementioned problem. The battery pack assembly comprises a first and second holding frame for holding a plurality of cells therebetween, a conductor for engaging the plurality of cells and having at least a first contact for engaging a first cell terminal and a second contact for engaging a second cell terminal, a resilient member being located between the conductor and one of the first or second holding frame to bear against the conductor adjacent the first contact and second contact.

The inventions described in these patent applications are effective for enabling rapid assembly and disassembly of the battery pack assembly for the recycling and reuse of cells within large format battery packs.

A first non-exclusive object of the invention is to provide a battery pack assembly, e.g. a large format battery pack assembly, that is configured such that the components can be even more readily accessed during maintenance and repair and/or can be assembled and/or disassembled more readily.

A first aspect of the invention provides a battery pack assembly in accordance with Claim 1.

A further aspect of the invention provides a battery pack assembly, the assembly comprising a plurality of cells having terminals, for example at each end thereof, a holding frame configured to accommodate at least a portion of one or more of the plurality of cells, an electrically conductive conductor plate for providing electrical contact to at least two of said plurality of cells, an electrical control unit configured to control electrical characteristics, e.g. the electrical output, of the battery pack assembly, and a separator plate, wherein the separator plate is located between the plurality of cells and the electrical control unit.

A further aspect of the invention may comprise a battery housing a battery pack assembly, which comprises one or more holding frames for retaining cells, an electrical control unit configured to control the electrical characteristics of the of the battery and a separator plate located between the one or more holding frames and the electrical control unit, the separator plate may be secured, for example releasably secured, to the one or more holding frames.

Fasteners (or fastening means) may be provided to allow the battery pack assembly to be removed from the housing. The housing may comprise a body portion and a closure member. Fasteners may be provided to allow the closure member to be used to remove the battery pack assembly from the body portion of the housing.

Advantageously, the separator plate adds structural rigidity to the assembly. Further, with the separator plate secured to a closure member, preferably having a handle, the closure member can be used to remove the battery pack assembly from the housing. Accordingly, removal of the assembly from the housing can be achieved without having to invert or tilt the housing. It will be appreciated that battery pack assemblies can be heavy (due to the presence of plural cells) and so inverting or tilting a housing to remove the assembly is burdensome and cumbersome and may be challenging and/or potentially dangerous. Using a closure member secured to a separator plate will mitigate that risk.

Further, the presence of a separator plate in a battery pack according to the invention enables the electrical control unit to be more readily accessed, e.g. for repair, replacement and/or upgrade of components within the battery pack assembly, without having to dismantle the plurality of cells held within the holding frame(s).

In the battery pack assembly of the invention, the or a electrically conductive conductor plate is located between the holding frame and at least some of the terminals of the plurality of cells.

In embodiments, the separator plate may comprise or consist of a non-electrically conductive or electrically insulative material, e.g. a polymer, selected from polypropylene, or from glass filled Nylon, or from coated aluminium wherein the coating is a non-electrically conductive material.

In embodiments, the battery pack assembly may comprise more than one holding frame, e.g. two, three, four, or more holding frames. Advantageously, the provision of more than one holding frame enables more than two set of cells, e.g. three sets, four sets, five sets or more to be stacked to form the battery pack assembly.

In embodiments, the battery pack assembly may comprise a first outer holding frame and/or a second holding frame. In embodiments, the battery pack assembly may comprise a first outer holding frame and/or a second holding frame and/or one or more intermediate holding frame(s).

In embodiments, the battery pack assembly may comprise a first plurality of cells located between the first outer holding frame and an intermediate holding frame, and a second plurality of cells located between the intermediate holding frame, and a second outer holding frame.

In embodiments, the battery pack assembly comprises a first outer holding frame (F), a first set of cells (C), an intermediate holding frame (F), a second set of cells (C), and a second outer holding frame (F). In embodiments, there may be more than one intermediate holding frame (F), for example, two, three or more intermediate holding frames (F), for example, situated between a first and second outer holding frames, with a plurality of cells situated between each holding frame. In embodiments, the holding frame (F)—cell (C)—holding frame (F) (i.e. FCF) architecture can be repeated plural times to form an FCFCF architecture, or FCFCF. . . . CF architecture. In embodiments, the battery pack assembly comprises the architecture FCFCFC. . . . F.

Advantageously, this architecture allows plural sets of cells to be stacked in a battery pack assembly.

The or each intermediate holding frame may be re-bated with respect to the facing surface of the separator plate. Advantageously, such a rebate provides an air gap which can help with cooling of the cells (e.g. passive cooling relying on the presence of the gap, or active cooling where a coolant is circulated within the gap).

The one or more holding frame(s) each has a first major surface, a second major surface, and a periphery. In embodiments, a peripheral wall may be provided, for example extending from one or both of the first major surface and the second major surface of one or more or each holding frame.

The holding frame may comprise a first plurality of cavities. The holding frame may comprise a second plurality of cavities. The first and/or second plurality of cavities may be provided for the receipt of fasteners. If the holding frame has a first edge and a second edge, the first plurality of cavities may be located on the first edge and/or the second plurality of cavities may be located on the second edge. In an embodiment the second plurality of cavities are preferably located on a different side of the holding frame from the first plurality of cavities.

The or a second holding frame may comprise a first plurality of cavities. The second holding frame may comprise a second plurality of cavities. The first and/or second plurality of cavities may be provided for the receipt of fasteners. If the second holding frame has a first edge and a second edge, the first plurality of cavities may be located on the first edge and/or the second plurality of cavities may be located on the second edge. In an embodiment the second plurality of cavities are preferably located on a different side of the second holding frame from the first plurality of cavities.

The first plurality of cavities of the first holding frame may allow securement from the top of the first holding frame. The second plurality of cavities of the first holding frame may allow securement from the bottom of the first holding frame.

The second plurality of cavities may be used to secure the holding frame(s) to the base of a housing. The first plurality of cavities may be used to secure the holding frame(s) to the base of a housing.

In embodiments, the separator plate is or may be secured to one or more holding frame(s), for example by removable fastening means, e.g. nuts and bolts, or screws.

In embodiments, the separator plate may be located in substantially perpendicular relations to the one or more holding frames. In embodiments, the separator plate may be positioned in parallel relations to the axes of the plurality of cells. For example, the plurality of cells may comprise or consist of cylindrical cells, and the separator plate may be positioned in parallel relations to the axes of the plurality of cylindrical cells.

In embodiments, the separator plate may be (e.g. reversibly) secured to one or more holding frames, for example to a peripheral wall of one or more of the holding frames, e.g. in perpendicular relations. In embodiments, the separator plate may be secured to a peripheral wall of a first, e.g. outer, holding frame and the separator plate may be secured to a peripheral wall of a second, e.g. outer, holding frame. In embodiments, the separator plate may be secured to a peripheral wall of a first, e.g. outer, holding frame using a first set of removable fastening means. In embodiments, the separator plate may be secured to a peripheral wall of a second, e.g. outer, holding frame using a second set of removable fastening means.

In alternative embodiments, the separator plate may be located in substantially parallel relations to the one or more holding frame. In embodiments, the separator plate may be positioned in perpendicular relations to the axes of the plurality of cells. For example, the plurality of cells may comprise or consist of cylindrical cells, and the separator plate may be positioned in perpendicular relations to the axes of the plurality of cylindrical cells.

In embodiments, the electrical control unit may be located adjacent the separator plate. In embodiments, the electrical control unit may be secured to the separator plate. In embodiments, the separator plate may be secured to the one or more holding frame(s) (e.g. secured to a peripheral wall of one or more holding frames, for example in perpendicular relations to the separator plate). In embodiments, the one or more holding frame(s) may each be located adjacent the electrically conductive conductor plate and/or the electrically conductive conductor plate may be located adjacent the terminals of the plurality of cells.

In embodiments, the electrical control unit may be (e.g. reversibly) secured to the separator plate by removable fastening means, e.g. nuts and bolts, or screws. Advantageously, the provision of removable fastening means instead of, for example adhesive, enables the components to be accessed for maintenance and repair without having to permanently damage the battery pack assembly.

In embodiments, the separator plate may be secured directly to the two holding frames. Advantageously, securement of the separator plate to the holding frames adds structural rigidity and/or may reduce the effects of deformation which may result from shock or vibration and also may act to resist any expansion caused by use of the cells. In addition, securement of the separator plate to the holding frame may also mitigate the impact of plastic creep over time. The separator plate is preferably able to maintain compression of the plurality of cells within the one or more holding frame(s), which provides shock and vibration resistance.

In embodiments, one or more (e.g. a set of) fasteners, for example removable fasteners fastening means may be used to secure the electrical control unit to one or both of the separator plate and a holding frame (e.g. a peripheral wall of a holding frame). In embodiments, a first set of removable fastening means may be used to secure the electrical control unit to both the separator plate and a first holding frame (e.g. a peripheral wall of a first holding frame) and a second set of removable fastening means may be used to secure the electrical control unit to both the separator plate and a second holding frame (e.g. a peripheral wall of a second holding frame). In embodiments, a further set of removable fastening means may secure the electrical control unit to the separator plate only.

In embodiments, the battery pack assembly comprises a housing. The battery pack assembly and housing in combination may form a battery according to the invention. In embodiments, the housing may completely enclose the plurality of cells and holding frame(s) of the battery pack assembly. In embodiments, the housing may be substantially cube or cuboid in shape. In embodiments, the housing may comprise a body portion and an closure. In embodiments, the body portion may comprise a base, the base comprising upstanding walls providing a rebate for receiving the one or more holding frames and the plurality of cells. In embodiments, the closure may comprise a removable lid. In embodiments, the closure, e.g. a removable lid, may comprise a handle.

In embodiments, the housing may be fabricated from one or more of the following materials; polypropylene, polycarbonate, polyurethane, and/or glass filled Nylon.

In embodiments comprising a housing, the housing comprises one or more terminals or connectors for making an electrical connection to an appliance, e.g. an electric car. The terminals may be located on the closure member.

The closure member may be secured to the separator plate by fasteners. The closure member may be secured to the separator plate by a first set of fasteners. The closure member may be secured to the housing. The closure member may be secured to the housing by a second set of fasteners. The second set of fasteners may extend through the separator plate.

A further aspect of the invention provides a battery, the battery comprising a housing, the housing comprising a closure and a body portion having a rebate for receiving one or more cells, a separator plate and control electronics (e.g. an electrical control unit), the separator plate being located between the rebate and the control electronics.

All features described apply to any aspect of the invention.

Advantageously, the separator plate allows access to the control electronics (e.g. an electrical control unit) without disassembly of the battery and/or without exposing the cells.

A yet further aspect of the invention provides a battery, the battery comprising a housing having a body portion and a closure for closing the body portion, a separator plate extending or extendable across the housing and being secured or securable to the body portion and/or the closure.

The body portion may be configured for receiving a plurality of cells. The battery may comprise a plurality of cells.

The closure may house or accommodate the control electronics. The closure may comprise a handle.

The plurality of cells may be provided as a battery pack assembly, for example a battery pack assembly comprising a holding frame configured to accommodate a least a portion of the plurality of cells, an electrically conductive conductor plate for providing electrical contact to at least two of said plurality of cells.

The separator plate may be secured or securable to the holding frame.

A still further aspect of the invention provides a battery, the battery comprising a housing for receipt of a battery pack assembly, the housing comprising a closure and a body portion, the battery pack assembly comprising a plurality of cells having terminals, for example at each end thereof, the plurality of cells being at least partially located within a holding frame, the battery further comprising a separator plate and an electrical control unit configured to control the electrical output of the battery, the separator plate being located between the plurality of cells and the electrical control unit, wherein removal of the closure allows access to the control electronics.

A yet further aspect of the invention provides a battery, the battery comprising an electrical control unit, a separator plate, a plurality of cells and a pair of holding frames, wherein the plurality of cells are retained between the holding frames and the separator plate is located between the cells and the electrical control unit, a first group of said plurality of cells having a first conductor plate to connect the first group in parallel and a second group of said plurality of cells having a second conductor plate to connect the second group in parallel, the first group and the second group being connected in series, the first conductor plate having a first extension or tab and the second conductor plate having a second extension or tab, the electrical control unit being electrically connected to the first extension or tab and the second extension or tab, preferably via an aperture in the separator plate, the serial output of the of the first group and second group being connected to the electrical control unit.

Preferably, the electrical control unit is able to monitor the condition of the first and/or second group by monitoring or measuring, via the first and/or second tab or extension, the voltage across the first group and/or the second.

Advantageously, the provision of a closure, e.g. a removable lid, enables components of the battery pack assembly, e.g. the electrical control unit, to be accessed for repair without having to dismantle the entire battery pack assembly. The separator plate functions as an interface between the plurality of cells and the electrical control unit, whilst ensuring that the plurality of cells does not require disassembly to access the electrical control unit.

In embodiments, an electrical connection may be made from the plurality of cells to the electrical control unit and/or from the electrical control unit to one or more terminals of the housing for making an electrical connection to an appliance, for example via one or more cables which may be provided as one or more cable harnesses or looms (i.e. the one or more cables are located within a protective sheath). In embodiments, electrical connection may be made from the plurality of cells to the electrical control unit via a first cable or cable loom (or a first set of cable looms). In embodiments, electrical connection may be made from the electrical control unit to one or more terminals of the housing for making an electrical connection to an appliance via a second cable or cable loom (or a second set of cable looms). In embodiments, the separator plate and/or the holding frame may comprise one or more apertures for locating the cables and/or one or more cable looms therethrough, e.g. for making an electrical connection from the plurality of cells to the electrical control unit.

The battery pack assembly (and the battery) may have conductor plates which connect the cells in series and/or parallel. One or more of the conductor plates may comprise a tab or extension by which electrical contact may be established between the electrical control unit and the cells, e.g. via one or more cables extending from or connected to the tab or extension. The one or more cables may be removably secured to the tab or extension, for example by a screw connection. Advantageously, removably securing the cables to the tabs or extensions ensures that rapid and effective assembly/disassembly and/or replacement can be achieved. In embodiments with a rebated intermediate holding plate defining a gap or space between the intermediate holding space and the separator plate, the one or more cables may extend through the gap or space.

The separator plate may comprise one or more cut-outs or apertures e.g. three cut-outs or apertures. The cables may extend through the cut-out or aperture in the separator plate.

The tabs or extensions may be located at a separator plate-facing location of the holding frame to facilitate connectivity.

The housing may also function as a structural member within the battery pack assembly by maintaining compression of the plurality of cells within the holding frame. In embodiments, the plurality of cells are held within the one or more holding frames by compression provided by the housing. No additional fastening means to secure two or more holding frames with respect to one another need to be provided. In this way, the housing provides shock and vibration resistance without the presence of additional compression points on the holding frame.

In embodiments, the battery pack assembly may comprise an electrically conductive conductor plate for providing electrical contact to at least two of said plurality of cells. In embodiments, the electrically conductive conductor plate may be located between a holding frame and the terminals of the plurality of cells.

In embodiments, the closure, e.g. the removable lid, may be secured to one or more components, e.g. the separator plate, with removable fastening means, e.g. nuts and bolts, or screws. Advantageously, the provision of removable fastening means instead of, for example adhesive, enables the components, e.g. the electrical control unit, to be accessed for maintenance and repair without having to permanently damage the battery pack assembly.

In embodiments, the removable fastening means for securing the closure to one or more components, e.g. the separator plate, may comprise a first set of removable fastening means (e.g. two fastening means, for example two screws) configured to secure the closure to the separator plate, and a second set of removable fastening means (e.g. eight fastening means, for example eight screws) configured to secure the closure to the separator plate.

In embodiments, the battery may comprise removable fastening means to secure the body portion (e.g. the base of the body portion) of the housing to one or more holding frames. In embodiments, the removable fastening means may comprise or be, for example nuts and bolts, or screws.

In embodiments wherein the battery comprises more than one holding frames (e.g. two or three, for an example two outer holding frames and an intermediate holding frame), the battery may further comprise one or more (e.g. a first set of) removable fastening means configured to secure the body portion to a first holding frame (e.g. a peripheral wall of a first holding frame), and one or more (e.g. a second set of) removable fastening means configured to secure the body portion to a second holding frame (e.g. a peripheral wall of a second holding frame). In embodiments wherein the housing has a cube or cuboid shape, the battery may comprise four removable fastening means, e.g. four screws, for example wherein one removable fastener is located at or near a corner of the body portion.

Advantageously, provision of removable fastening means configured to secure the one or more holding frames to the body portion of the housing enables the user to remove these fastening means to access the plurality of cells whilst the closure of the housing remains secured to the separator plate, which is turn is secured to the one or more holding frames. In embodiments wherein the closure is a lid comprising a handle, the handle may be used to more easily remove the plurality of cells from the body portion of the housing, e.g. for maintenance and repair purposes.

In embodiments, the holding frame may have a first major surface and a second major surface, on one or both of the first major surface and the second major surface the holding frame having one or more cell-locating structures which are shaped and/or sized and/or configured to accommodate at least a portion of one or more cells. In embodiments, the one or more cell-locating structures may comprise a first wall upstanding from one of the first or second major surfaces.

The at least one cell-locating structure may comprise one first upstanding wall or more than one upstanding wall, e.g. a second, third, or n^{th} upstanding wall. The at least one cell-locating structure may comprise two, three, four, five, six, or plural further upstanding walls. The one and/or second and/or plural upstanding walls may at least partially define a cell-locating zone on the frame.

Advantageously, the holding frame may comprise an array of upstanding walls providing cell-locating structures. At least some of the array of upstanding walls may cooperate to provide one or more cell-locating structures.

The or each upstanding wall may extend from a base portion, adjacent the major surface from which the upstanding wall extends, to a terminal edge.

The first upstanding wall may be associated with a first cell-locating zone, the second upstanding wall may be associated with a second cell-locating zone, the third or plural upstanding wall may be associated with a third or n^{th} cell-locating zone.

The cell-locating structure may comprise a single upstanding wall arranged to completely or substantially bound a cell locating zone. Alternatively, each cell-locating structure may comprise plural, e.g. two, three, or four, upstanding walls to provide a discontinuous boundary about the or a cell-locating zone. The provision of plural upstanding walls which together provide a discontinuous boundary about the or a cell-locating zone may be preferable for weight and thermal management reasons.

in embodiments wherein a peripheral wall is provided on the holding frame, for example extending from one or both of the first major surface and the second major surface, the at least one cell-locating structure may be located inboard of the periphery.

Where the holding frame is configured for use as an outer holding frame, the cell-locating structure(s) are provided on one of the first major surface or the second major surface. Where the holding frame is configured for use as an intermediate holding frame the cell-locating structure(s) are provided on both of the first major surface and the second major surface. In a battery pack assembly the intermediate holding frame is located between two separate arrays of cells, one array adjacent the first major surface the second array adjacent the second major surface.

The or each cell-locating structure may comprise an opening for receipt of a cell.

In embodiments, one or each of the first and second major surface of the holding frame may comprise plural cell-locating structures. In embodiments, one or each major surface the holding frame may comprise two or more cell-locating structures, for example, three, four, five, six, seven, eight, nine, ten, eleven, twelve, thirteen, fourteen, fifteen, sixteen, seventeen, eighteen, nineteen, twenty, or more than twenty cell-locating structures. That is, each major surface of the holding frame may be configured to seat, three, four, five, six, seven, eight, nine, ten, eleven, twelve, thirteen, fourteen, fifteen, sixteen, seventeen, eighteen, nineteen, twenty, or more than twenty cells.

In embodiments, each cell locating structure has a diametrical dimension. The diametrical dimension may be the maximum transverse distance across a cell locating zone at a position proximate the first or second major surface of the holding frame from the which cell-locating structure extends.

When the battery pack assembly comprises cylindrical cells, the cell-locating structures may define a circular or substantially circular cell-locating zone. The upstanding wall may comprise a cylindrical or part cylindrical shape. The one or more upstanding walls may together define a cylindrical or part-cylindrical perimeter about a cell-locating zone. For example, the one or more upstanding walls may comprise an upstanding wall having a concave arcuate shape forming a generally cylindrical region to seat a cylindrical cell.

In embodiments, the battery pack assembly may comprise 18650 cylindrical cells having a cell diameter of 18 mm and a cell height of 65 mm. In embodiments, the one or more cell-locating structure may be sized to seat an 18650 cylindrical cell. In embodiments, the diametrical dimension may be greater than 18 mm and less than 19 mm, e.g. greater than 18 mm and less than 18.5 mm, or less than 18.4 mm, or less than 18.3 mm, or less than 18.2 mm, or less than 18.1 mm.

In embodiments, the battery pack assembly may comprise 21700 cylindrical cells having a cell diameter of 21 mm and a cell height of 70 mm. In embodiments, the diametrical dimension may be greater than 21 mm and less than 22 mm, e.g. greater than 21 mm and less than 21.5 mm, or less than 21.4 mm, or less than 21.3 mm, or less than 21.2 mm, or less than 21.1 mm.

In embodiments, the battery pack assembly may comprise 26650 cylindrical cells having a cell diameter of 26 mm and a cell height of 65 mm. In embodiments, the diametrical dimension may be greater than 26 mm and less than 27 mm, e.g. greater than 26 mm and less than 26.5 mm, or less than 26.4 mm, or less than 26.3 mm, or less than 26.2 mm, or less than 26.1 mm.

In embodiments, the battery pack assembly may comprise 32650 cylindrical cells having a cell diameter of 32 mm and a cell height of 65 mm. In embodiments, the diametrical dimension may be greater than 32 mm and less than 33 mm, e.g. greater than 32 mm and less than 32.5 mm, or less than 32.4 mm, or less than 32.3 mm, or less than 32.2 mm, or less than 32.1 mm

The height of the upstanding wall, may be less than 70 mm, or less than 65 mm, or less than 60 mm, or less than 55 mm, or less than 50 mm, or less than 45 mm, or less than 40 mm, or less than 35 mm, or less than 30 mm, or less than 25 mm, or less than 20 mm, or less than 15 mm, or less than 10 mm. The height of the upstanding wall, may be between 10 to 30 mm, for example, between any one of 10, 11, 12, 13, 14, 15, 16, 17, 18, 19, 20, 21, 22, 23, 24, 25, 26, 27, 28, 29 mm to any one of 30, 29, 28, 27, 26, 25, 24, 23, 22, 21, 20, 19, 18, 17, 16, 15, 14, 13, 12, 11 mm. The height of the upstanding wall may be between 15 to 23 mm, e.g. greater than or equal to any one of 15, 16, 17, 18, 19, 20, 21, 22 mm and less than or equal to any one of 23, 22, 21, 20, 19, 18, 17, 16 mm. The height of the upstanding wall may be between 15 to 23 mm, e.g. from any one of 15, 16, 17, 18, 19, 20, 21, 22 mm to any one of 23, 22, 21, 20, 19, 18, 17, 16 mm.

Advantageously, the height of the upstanding wall may be selected depending on the diameter of the cells for which it is configured to hold. Cells having a smaller diameter require a taller upstanding wall, whereas cells having a relatively larger diameter require a relatively shorter upstanding wall. The upstanding wall may have a total height (orthogonal distance from the adjacent major surface) of from 10 to 30 mm. It has been found that for 18650, 21700, 26650, 32650 cells, a height of between 15-23 mm may be optimal for providing stability to the battery pack assembly, whilst saving on material costs. Thus, a frame configured to house 18650 cells may have a first diametrical dimension of less than 19 mm and a height of upstanding wall of greater than 23 mm (e.g. from 23 to 26 mm) whereas a frame configured to house 32650 cells may have a first diametrical dimension of less than 33 mm and a height of upstanding wall of around 15 mm (e.g. from 13 to 18 mm).

In embodiments wherein the holding frame comprises one or more cell locating structure(s) on both major surfaces, the cell-locating structure(s) of the first surface of the holding frame and the second surface of the holding frame may be dissimilar. In embodiments, the height of the upstanding wall of the one or more cell-locating structure(s) of the first surface of the holding frame may be greater than the height of the upstanding wall of the one or more cell-locating structure(s) of the second surface of the holding frame.

In embodiments, the holding frame may comprise a generally flat base and one or more side walls, e.g. upstanding side walls. In embodiments, the holding frame may comprise a side wall which upstands from the periphery of the base of the one or more, or each, holding frame. The side walls may be facing side walls. In embodiments, one or more or each holding frame may comprise an upstanding side wall which extends around the entire periphery of the base of the one or more, or each, holding frame. In alternative embodiments, the upstanding side wall may extend around a portion of the periphery of the base of the one or more, or each, holding frame. In an embodiment the side wall may be discontinuous. In embodiments in which the holding frame is to be used with cylindrical cells, at least one side wall, and preferably facing side walls, may further comprise a one or more concave arcuate sections complementary to the side wall of the cells to be inserted into the assembly.

In embodiments, one or more of the side walls located at the periphery of the base of the holding frame may have a thickness of between 2.0 to 3.0 mm, e.g. from any one of 2.0, 2.1, 2.2, 2.3, 2.4, 2.5, 2.6, 2.7, 2.8, 2.9 mm to any one of 3.0, 2.9, 2.8, 2.7, 2.6, 2.5, 2.4, 2.3, 2.2, or 2.1 mm.

Advantageously, provision of an upstanding side wall and/or encasing one or more ends or terminals of the cells, in use, provides a more secure battery pack assembly with respect to the plurality of cells. This provides better contact between the conductor and the cell terminals, which may be further enhanced by one or more resilient members, which may be located between the conductor and one or more of the holding frames. This is particularly advantageous when no permanent fastening means (e.g. adhesive) are provided within the battery pack assembly, such that the assembly is rigid and stable in use, but may be readily disassembled into its component parts.

In alternative embodiments, the holding frame may comprise a base portion with no side walls. The holding frame may further comprise a plurality of protrusions extending perpendicularly from the base, for example to delimit or space the adjacent portions of the cells from one another. For example, the walls of the base protrusions may comprise a plurality of concave arcuate sections complementary to the facing portions of the cells to be inserted into the assembly.

In embodiments, the holding frame may be fabricated from an electrically insulative material, for example, a polymer or plastic material. The holding frame may be fabricated using any suitable method, e.g. injection moulding of a suitable material. Suitable materials for fabricating the holding frames include Nylon, PPE (polyphenylene ether), ABS (acrylonitrile butadiene styrene), PA (polyamide), PP (polypropylene), PS (polystyrene).

In embodiments, the battery pack assembly may further comprise fastening means or a fastener configured to reversibly hold the one or more holding frame and the plurality of cells together, for example, to reversibly hold the first and second outer holding frames with respect to one another in a closed condition.

The fastening means may be any suitable reversible fastening means known to the skilled person. For example, the fastening means may comprise or may consist of a plurality of fastening nuts and/or bolts. Each fastening nut may each thread through a hole in each of the two outer holding frames and act to compress the assembly, encouraging contact between the cells and the conductor.

In embodiments, the battery pack assembly may comprise of a first set of cells positioned between a first outer holding frame and a holding frame, and a second set of cells positioned between a second outer holding frame and the holding frame, the first and second holding frames being in parallel relations, each cell being held longitudinally between the respective holding frame and holding frame by virtue of the fastening means being secured or ‘tightened’ to clamp the cells between the holding frames.

The fastening means or fastener causes terminals of the two cells to be urged against the conductor (and/or vice versa) and removal or loosening of the fastener or fastening means into an disassembled or open configuration enables the cells to be freed from the assembly.

This allows for the complete disassembly of a large format battery pack assembly into its individual components. The ability to completely disassemble the assembly permits the module to be repaired via the replacement of individual cells or other components, allows individual components of the module to be reused for further applications at the end of the useful life of the complete assembly, and allows for improved recycling as each of the individual components of the module can be separated and sorted for recycling accordingly. Further, it also allows for upgrades or replacement of components as may be required over the service life of the assembly.

As well as assisting manufacturers to meet EU waste management legislation, the ability to reuse, repair and recycle individual components of battery modules would also save money and resources for the manufacturers. Individual or multiple cells may be replaced with ease, meaning the assemblies could be repeatedly rebuilt at end of life instead of being disposed. It also presents the opportunity for the reuse of cells from a module in other energy storage applications when they no longer perform in the original module application or when the module is no longer required.

The battery pack assembly may comprise more than one electrically conductive conductor plate. In embodiments, the one or more conductor plate(s) may comprise one or more cooperating members. In embodiments, the cell-locating structures of the holding frame and the cooperating members of the conductor plate cooperate to ensure that the conductor plate(s) is/are appropriately located or locatable with respect to the holding frame.

In embodiments, the one or more conductor plate(s) may comprise or consist of a sheet comprising one or more apertures. Each aperture may correspond to a respective upstanding wall, e.g. a respective formation. In embodiments, the cell-locating structure(s) of the holding frame may comprise one or more upstanding walls, and the conductor plate may comprise one or more apertures.

In embodiments, the conductor plate may comprise one or more protrusions on a major surface, for example on a first major surface. In embodiments the conductor plate may comprise one or more rebates on a major surface, for example on a second major surface.

In an embodiment the conductor plate may comprise a rebate on the second major surface that corresponds to the protrusion the first major surface of the conductor plate.

In embodiments, the conductor plate may have respective protrusions for making contact with each of said at least two cells. In a closed condition of the battery pack assembly, the protrusions of the conductor plate extend towards the cell terminals.

The one or more protrusions may be located between said conductor plate cooperating members. The conductor plate cooperating members may describe a conductor plate cooperating member array. The first and second (e.g. and n^{th}) contact may form a contact array. The contact array and the conductor cooperating member array may be displaced with respect to one another, such that a contact does not overlie a conductor cooperating member.

In embodiments, the holding frame may bear directly against said conductor plate to cause the protrusions of the conductor plate to make electrical contact with a cell terminal in a closed condition. Advantageously, in embodiments wherein the conductor plate of the battery pack assembly is provided with one or more protrusions, each protrusion is configured to contact the one or more cell terminals.

Advantageously, the protrusions aid electrical contact to be made between the one or more conductor plates and the cell terminals. In a closed condition of the battery pack assembly, the protrusions of the conductor plate extend towards the cell terminals. The protrusions of the conductor plate may be urged into contact with the cell terminals by compression in the housing. This provides effective electrical contact between the conductor and the cell terminals, when the battery is in use. This prevents failure and/or disconnection of the cell terminals from the conductor.

It has been surprisingly found that said housing is capable of generating sufficient compressive force to urge the protrusions of the conductive means into contact with the cell terminals for electrical connection. It has been further surprisingly found that quality electrical contacts are maintained even when the assembly undergoes vibration.

Advantageously, the battery pack assembly of the present invention comprises fewer components, which enables rapid assembly and disassembly, and ease of manufacture. Furthermore, the provision of elastomeric protrusions on one or more holding frames may be avoided, which is advantageous from a manufacturing perspective.

In embodiments, the one or more conductor plate(s) may be fabricated from a conductive plastics material or from one or more metal sheets. The one or more conductor plate(s) may be fabricated from aluminium, e.g. aluminium sheet. The conductor plate, such as the metal sheet, e.g. aluminium sheet, may be between 0.1 to 1.0 mm in thickness, e.g. from any one of 0.1, 0.2, 0.3, 0.4, 0.5, 0.6, 0.7, 0.8, 0.9 mm to any one of 1.0, 0.9, 0.8, 0.7, 0.6, 0.5, 0.4, 0.3, or 0.2 mm in thickness. Preferably, the metal sheet, e.g. aluminium sheet, is between 0.6 to 1.0 mm in thickness, e.g. between 0.7 to 0.9 mm thick, or 0.8 mm thick. Conductor plates are typically rigid, meaning that they are self-supporting.

The protrusions may be fabricated, for example, by stamping a metal sheet, which forms the conductor plate. Advantageously, the protrusions aid electrical contact to be made between the conductor plate, e.g. one or more conductive plates, and the cell terminals. One or more (e.g. each) of the protrusions will extend from the first major surface of the conductor plate. The second major surface may have a corresponding depression. This is advantageously achieved by stamping from a thin conductive material, e.g. a metal sheet. In embodiments, the protrusions extend from 0.1 to 3 mm from the plane of the conductor plate, e.g. from any one of 0.1, 0.2, 0.3, 0.4, 0.5, 0.6, 0.7, 0.8, 0.9, 1.0 mm to any one of 3, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1 mm from the plane of the conductive plate. The protrusions may extend from 0.5 to 2.0 mm from the plane of the conductive plate, say 0.6 to 1.9, 0.7 to 1.5, 0.8 to 1.4, 0.8 to 1.2 mm from the plane of the conductor plate.

The conductor plate preferably connects two or more cell terminals in parallel or series. Preferably, the arrangement of the conductor plate in the holding frame is complementary, such that the conductor plate and cells together form a complete circuit when the plurality of cells are held within the holding frame, electrically connecting all of the cells in the assembly in parallel and/or series. For example, the cells may be arranged with neighbouring cells alternatively positioned with the positive terminal upwards and the positive terminal downwards respectively, and the positive and negative terminals on each side being connected together, so that a complete circuit is formed.

The battery pack assembly may comprise more than one conductor plate. In embodiments, there may be provided two or more, e.g. three, four, five, or n conductor plates (where ‘n’ is a positive integer). In embodiments, one or more conductor plate(s) may be associated with a holding frame. In embodiments, a second one or more conductor plate(s) may be associated with a second holding frame. The conductor plates may be any shape which would cover more than one cell terminal, such as a sheet, or rectangular, U-shaped, S-shaped, L-shaped, T-shaped, H-shaped, and so on.

The one or more conductor plate(s) preferably connects two, three or more cell terminals in series. Preferably, the arrangement of the one or more conductor plate(s) in each of the two holding frames is complementary, such that they form a complete circuit when the plurality of cells are held within holding frame, or within two holding frames, electrically connecting all of the cells in the assembly in series. For example, the cells may be arranged with neighbouring cells alternatively positioned with the positive terminal upwards and the positive terminal downwards respectively, and the positive and negative terminals on each side being connected together, so that a complete circuit is formed.

In embodiments, the conductor plate may comprise n protrusions for making contact with n cell terminals.

The one or more or each conductor plate, may further comprise an electrical terminus to connect the appropriate conductor or conductor, e.g. conductor plate, to external means, e.g. an external circuit, to use the electrical power.

The holding frame may be fabricated from a polymeric material. The polymeric material may comprise one or more of Nylon (polyamide), polypropylene, polyurethane, acrylonitrile butadiene styrene. The polymeric material may comprise reinforcement. The polymeric material may comprise fibre reinforcement, for example, glass, ceramic, carbon fibres or strands. The conductor plate may be fabricated from aluminium sheet, which is stamped to form the protrusions, each of which extend by 0.8 to 1.2 mm from the plane of the conductor plate. It has been surprisingly found that a battery pack assembly according to the invention when assembled using fasteners tightened to a torque, of say between 0.5-10 Nm, preferably 0.5 to 2 Nm, e.g. 0.75 to 2 or 2 Nm, say 1 and 2 Nm, is able to maintain the contact between cells and conductor plates in the same manner as, for example, where a spring or an elastomeric protrusion is deployed. This is particularly surprising for static or non-static uses, where the assembly may undergo significant vibration.

Additionally or alternatively, the battery pack assembly may further comprise one or more resilient member(s). In embodiments, the one or more resilient member(s) is located between the conductor plate and the holding frame to bear against the conductor plate to make electrical contact with one or more cell terminals in said closed condition.

In the battery pack assembly comprising one or more resilient member(s), the conductor is located between the resilient member and the cell terminals of said plurality of cells. The conductor comprises a first major surface for engaging the first, second, . . . n^{th} cell terminal, and a second major surface against which the resilient member bears. By the term ‘adjacent’, we mean that the respective contact on the first major surface of the conductor is in engagement with respective cell terminal and that the resilient member bears against the second major surface of the conductor in a corresponding position.

In embodiments, the battery pack assembly comprises a first resilient member located between a first conductor and a first holding frame, and a second resilient member located between a second conductor and a second holding frame.

The resilient member may bear against plural conductive plates of the conductor. In an embodiment the resilient member may bear against most or all of the conductive plates of the conductor.

In embodiments, the first contact of the conductor for engaging a first cell terminal and/or the second contact of the conductor for engaging a second cell terminal, is provided by a protrusion. The first contact may comprise a protrusion on a first major surface of the conductor. The first contact may comprise a rebate on a second major surface of the conductor. The rebate may correspond with the protrusion. There may be provided ‘n’ contacts for engagement with respective ‘n’ cell terminals. For example, a contact, e.g. a protrusion, may be provided on the conductor for engaging an nth cell terminal. A contact, e.g. a protrusion, may be provided on the conductor to engage each cell terminal of the plurality of cells located within the battery pack assembly such that one contact, e.g. protrusion, is provided per cell terminal. The conductor will be oriented such that the protrusion will typically be directed towards the cell terminal.

In a closed condition of the battery pack assembly, the protrusions of the conductor extend towards the cell terminals. The portion of the resilient member adjacent the protrusion of the conductor is preferably urged to extend into the corresponding depression, where present, of the conductor, e.g. by placing the battery pack assembly into a or the housing. The resilience of the resilient member provides effective or intimate electrical contact between the conductor, for example a respective protrusion, and the cell terminals, when the battery pack assembly is in use.

The resilient member may be a unitary body. The resilient member may comprise a sheet. The resilient member may comprise one or more resilient sheets associated with a holding frame of the battery pack assembly. In embodiments, the resilient member may comprise two or more, e.g. three, four, five, resilient sheets. The resilient member may be seated within one or more of the holding frames. The resilient member may be sized to extend to one or more internal edges, and/or to the inner perimeter of a holding frame. Alternatively, the resilient member may be sized to have a smaller major surface than that of a holding frame.

In embodiments, the resilient member may comprise or consist of one or more sheets of resilient material, for example, a polymeric or elastomeric material. The resilient member may be fabricated from a rubber material. In an embodiment the resilient member may be fabricated from, or comprise, a silicone-based material, e.g. silicone rubber. In an embodiment the resilient material may be fabricated from ethylene-propylene-diene rubber, hydrogenated nitrile butadiene rubber or other rubbers. The resilient member may be formed from an expanded polymeric material, for example expanded polystyrene. The resilient member will have sufficient heat resistant properties to withstand typical battery operating temperatures.

Advantageously, the resilient member acts to encourage electrical contact between the first, second, or nth contacts of the conductor for engagement with one or more cell terminals. For example, a portion of the resilient member may be forced into the depression corresponding to the protrusion of the conductor, when the assembly is under compression, e.g. from the fastening of the fastening means or fastener. This ensures intimate electrical contacts are maintained even when the assembly undergoes vibration.

In addition, the provision of a resilient member, for example a resilient member formed as a unitary body, e.g. that extends to one or more internal edges of the holding frame, provides enhanced and uniform electrical contact between the cell terminals and the conductor. The provision of a single resilient member ensures ease of manufacture. Moreover, a unitary body is easily manufactured and/or replaced if and when the component wears out to enable greater recyclability of the components of the assembly.

In embodiments wherein the first contact comprises a rebate or one or more rebates, for example where the first contact comprises a protrusion on a first major surface of the conductor and a corresponding rebate on a second major surface of the conductor, the resilient member may extend into one or more rebates, for example the one or more rebates on the second major surface of the conductor.

The resilient member may comprise or consist of a sheet comprising apertures. Each aperture may correspond to a respective locating member, e.g. a respective formation.

In embodiments, the battery pack assembly comprises one or more conduction breaking means or conduction breaker. A conduction breaking means or conduction breaker may be positioned between each cell terminal, and the conductor or conductor, which may be a conductor plate. Preferably, a conduction breaking means or conduction breaker is provided between every cell terminal and the associated conductor or conductor. The purpose of the one or more conduction breaking means of conduction breaker is to break the electrical circuit between a cell and the conductor or conductor, when said cell exceeds a prescribed electrical and/or thermal limit. Upon exceeding a prescribed electrical and/or thermal limit, the conduction breaking means of conduction breaker severs the connection of the failed cell, i.e. a cell that has exceeded a prescribed electrical and/or thermal limit, isolating said failed cell from the rest of the battery pack assembly.

The conduction breaking means or conduction breaker may comprise a first conductive portion for making contact with the cell terminal, a second conductive portion for making contact with the conductor or conductor, an insulating portion, and a conduction breaker portion. The conduction breaking means or conduction breaker may comprise a metallic alloy, or a multi-metallic element and may comprise a bimetal fuse. The conduction breaker portion may comprise a low melting material, for example, a metal such as silver, or silver-plated copper, tin, or zinc, or alloys of the same, which melts upon exceeding the electrical and/or thermal limit determined by the melting point of the material.

Advantageously, the contact between the conduction breaking means or conduction breaker with both the conductor one on major surface, and the cell terminal on the opposite major surface, is increased upon ‘tightening’ of the fastening means when the battery pack assembly is under compression. More advantageously, the one or more conduction breaking means or conduction breaker allow the battery pack assembly to continue to function upon failure of an individual cell, by isolating the one or more failed cells from the other functioning cells in the battery pack assembly.

In embodiments, the battery pack assembly comprises a monitoring means or monitor for monitoring the status of each cell. The monitoring means may comprise an integrated electrical circuit, which monitors the status of each cell by detecting the number of triggered conduction breaking means or conduction breakers resulting from failed cells, i.e. a cell that has exceeded a prescribed electrical and/or thermal limit, within the battery pack assembly. The monitoring means may comprise a method of determining the condition of the battery pack assembly. For example, the monitoring means may transmit data, which has been collected about the status of each cell within the assembly, to be fed through an algorithm to compare with the optimal function of the assembly, to determine the number of fully functioning cells and the number of failed cells. Advantageously, this provides information on the overall condition and remaining useful life of the battery pack assembly. More advantageously, this information may be used to inform the user of maintenance requirements, and of potential safety hazards from using an under-performing battery pack assembly.

The battery pack assembly may comprise cells of any format including laminates, pouch, cylindrical, and/or prismatic, although circular cells are preferred.

In an embodiment the battery pack assembly has a mass of 12 kg or more and/or a power storage of 1 kWh or more. In an embodiment the battery pack assembly is a large format battery pack.

The battery pack assembly of the invention may be readily demountable and/or separable into its constituent parts, thereby allowing for the replacement or maintenance of one or more of the cells within the battery pack assembly.

The battery or battery pack assembly of the invention may be used as a power source for consumer goods, vehicles, for example, electric vehicles or as a renewable energy store (for example when linked to a renewable energy source such as solar, wind or tide power generator).

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

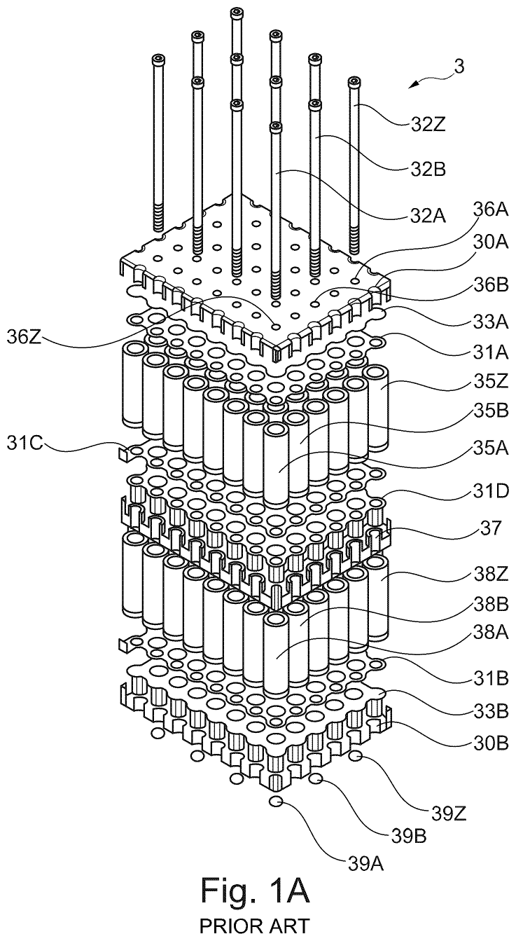

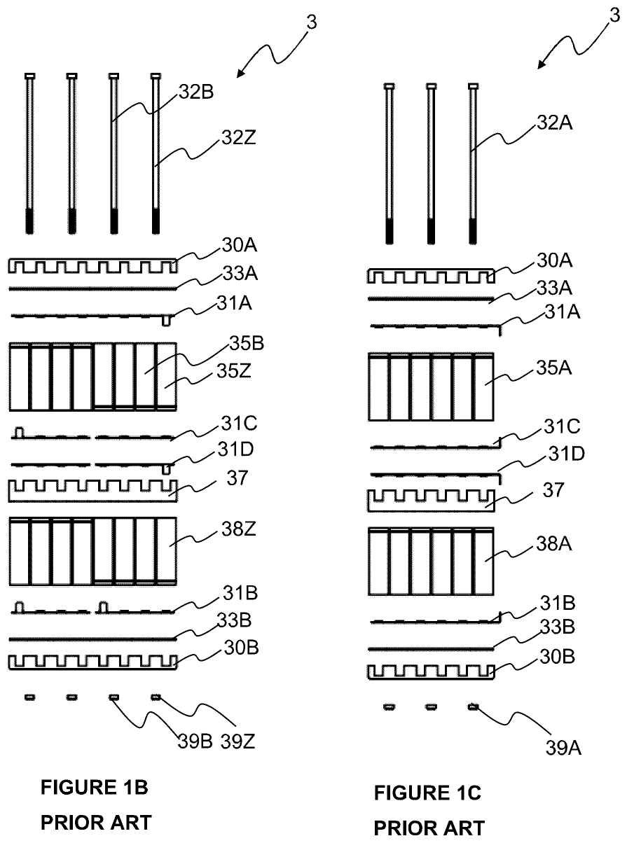

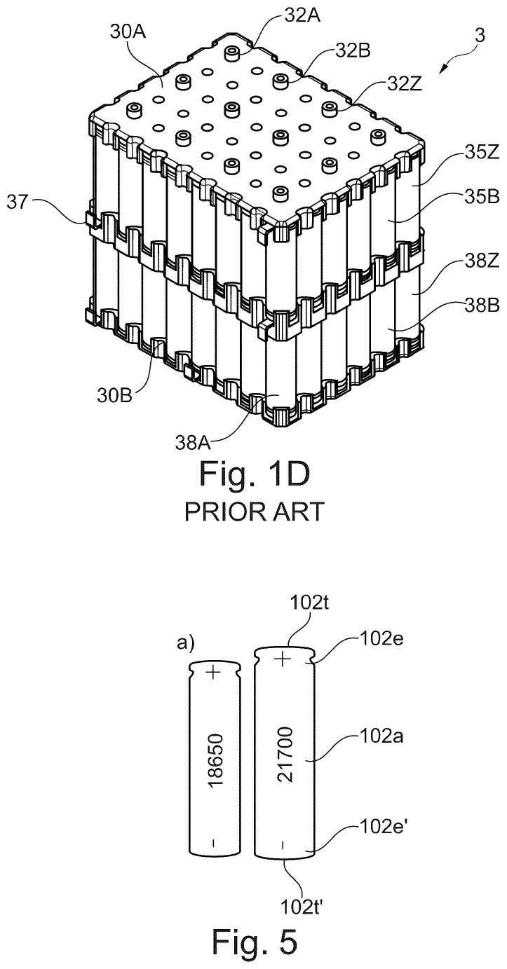

FIG. 1A to 1C are exploded views of a battery pack assembly according to the prior art;

FIG. 1D is a plan view of the battery pack assembly of FIGS. 1A to 1C according to the prior art;

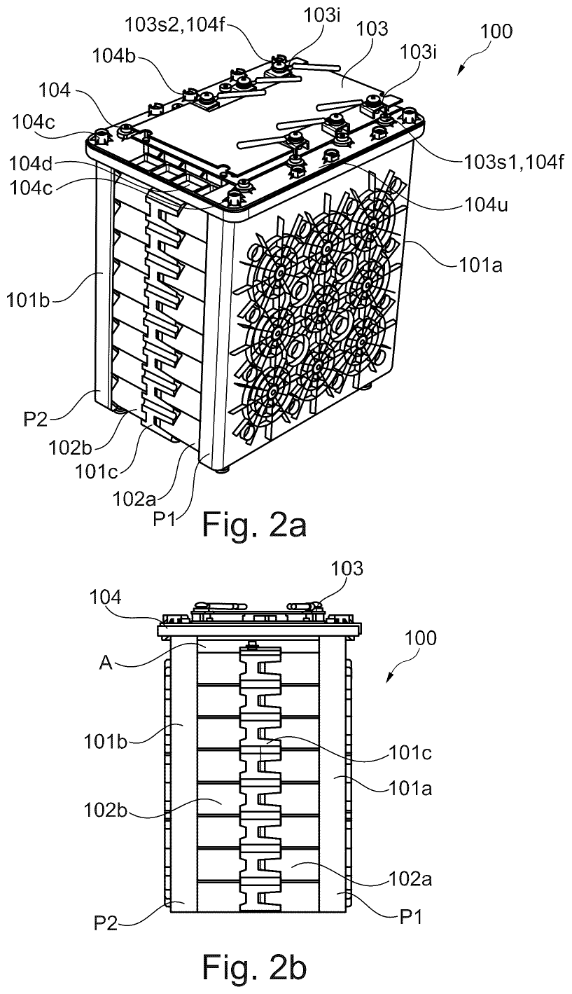

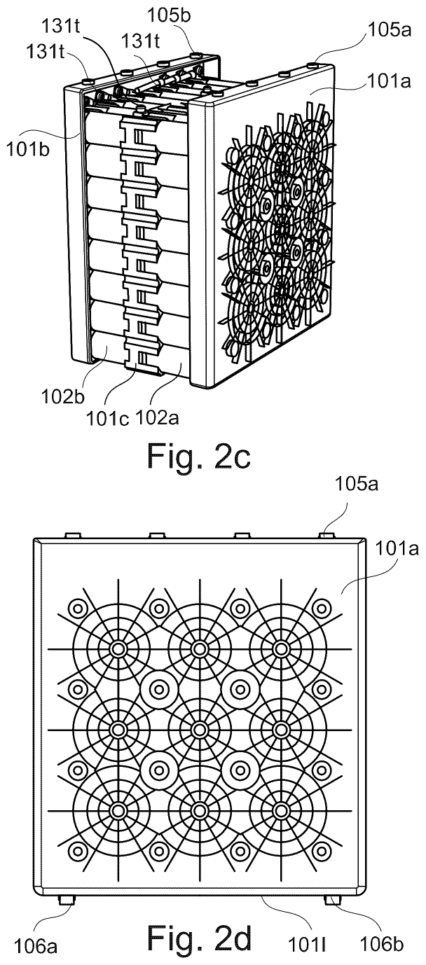

FIG. 2a to 2d are views of a battery pack assembly according to a first embodiment of the invention;

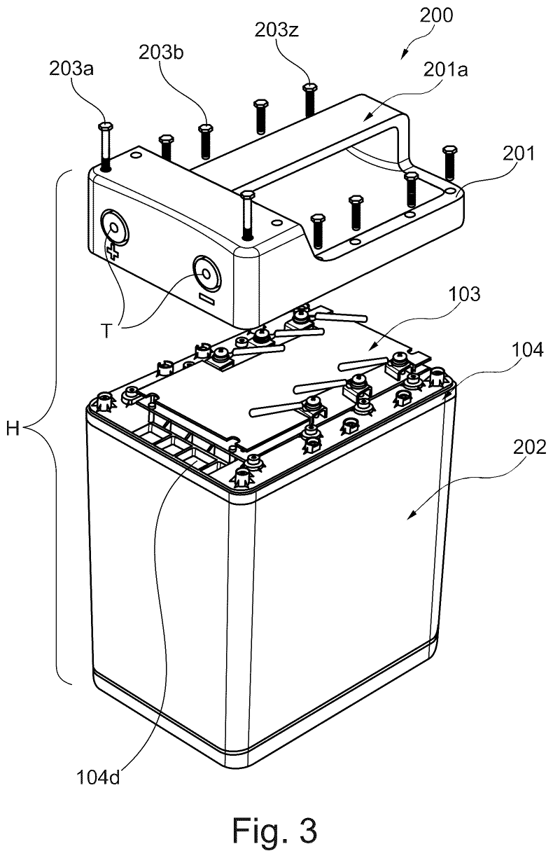

FIG. 3 is a battery comprising the battery pack assembly of FIG. 2a to 2d according to a second embodiment of the invention;

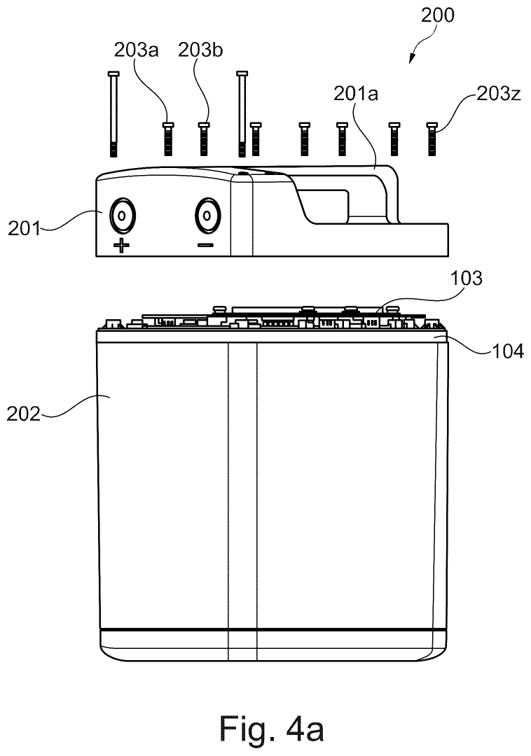

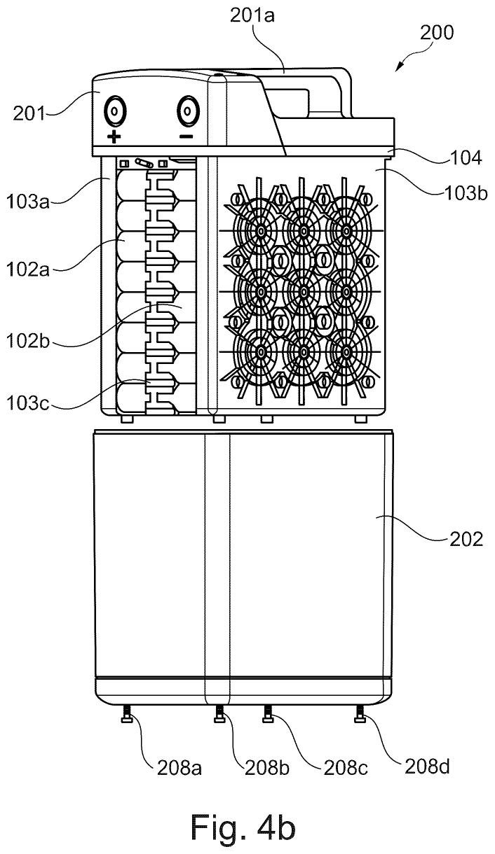

FIGS. 4a and 4b provide partially exploded views of the battery of FIG. 3; and

FIG. 5 is a schematic representation of a circular cell.

Referring first to FIGS. 1A to 1C, there is shown exploded views of a battery pack assembly 3 disclosed in our earlier patent application WO2020128533. Referring also to FIG. 1D, there is shown the battery pack assembly 3 in an assembled or closed condition.

The battery pack assembly 3 comprises a first outer holding frame 30A, a second outer holding frame 30B, an intermediate holding frame 37, a first conductor 31A, a second conductor 31B, a third conductor 31C, a fourth conductor 31D, a plurality of fasteners 32A, 32B, . . . 32Z, a first resilient member 33A, and a second resilient member 33B.

The battery pack assembly 3 is configured in use to hold a first plurality of cells 35A, 35B, . . . 35Z between the first outer holding frame 30A and the intermediate holding frame 37 in a longitudinal configuration. The battery pack assembly 3 is further configured in use to hold a second plurality of cells 38A, 38B, . . . 38Z between the intermediate holding frame 37 and the second outer holding frame 30B in a longitudinal configuration.

The third conductor 31C is located between the first plurality of cells 35A, 35B, . . . 35Z and the fourth conductor 31D. The fourth conductor 31D is located between the third conductor 31C and the intermediate holding frame 37. The intermediate holding frame 37 is located between the fourth conductor 31D and the second plurality of cells 38A, 38B, . . . 38Z.

In this embodiment, the battery pack assembly 3 is configured to hold forty-eight cells in the first plurality of cells 35A, 35B, . . . 35Z, and forty-eight cells in the second plurality of cells 38A, 38B, . . . 38Z. The cells may, for example, lithium ion batteries. For convenience only three cells are labelled for each set in FIG. 1A.

The first outer holding frame 30A further comprises slots 36A, 36B, . . . 36Z for receiving the fasteners 32A, 32B, . . . 32Z.

The second outer holding frame 30B and the intermediate holding frame 37 also comprise slots (not shown) for receiving the fasteners 32A, 32B, . . . 32Z such that each fastener, for example 32A, is inserted into the slot 36A of the first holding frame 30A and is received within a corresponding slot (not shown) in the intermediate holding frame 37 and the second outer holding frame 30B. The fasteners 32A, 32B, . . . 32Z are bolts, twelve bolts being provided. The slots 36A, 36B, . . . 36Z are configured to receive the fasteners 32A, 32B, . . . 32Z and as such there are twelve slots provided. The fasteners 32A, 32B, . . . 32Z are secured in place by nuts 39A, 39B, . . . 39Z.

In use, the fasteners 32A, 32B, . . . 32Z are received in the slots 36A, 36B, . . . 36Z, and are configured using compressive forces to reversibly hold the first outer holding frame 30A, the intermediate holding frame 37, and the second outer holding frame 30B with respect to one another in a closed or assembled condition.

In the closed or assembled condition, the fasteners 32A, 32B, . . . 32Z cause terminals of the first plurality of cells 35A, 35B, . . . 35Z and the second plurality of cells 38A, 38B, . . . 38Z to be urged against the first conductor 31A and the second conductor 31B respectively.

The first conductor 31A is positioned between the first resilient member 33A and the terminals of each of the cells in the first set 35A, 35B, . . . 35Z. In a like manner, the second conductor 31B is positioned between the second resilient member 33B and the terminals of each of the cells in the second set 38A, 38B, . . . 38Z.

The conductive plates 31A, 31B, 31C comprise plural protrusions. There is provided one protrusion per cell terminal such that the conductive plates are in electrical contact with each cell terminal via a protrusion.

In an assembled configuration, the holding frame 30A is positioned adjacent the resilient member 33A, and the conductive plate 31A is positioned between the resilient member 33A and the terminal of the first set of cells 35A, 35B, . . . 35Z.

Similarly, in an assembled configuration, the holding frame 30B is positioned adjacent the resilient member 33B, and the conductive plate 31B is positioned between the resilient member 33B and the terminal of the second set of cells 38A, 38B, . . . 38Z.

The first and second conductor 31A, 31B, and the first and second resilient members 33A, 133B each comprise apertures. The apertures are located in areas that are not in contact with the cell terminals when the battery pack assembly 3 is assembled and correspond and cooperate with the cell-locating structures.

The first resilient member 33A functions to urge the first conductor 31A into contact with the terminals at the first end of each of the plurality of cells 35A, 35B, . . . 35Z. In a like manner, the second resilient member 33B functions to urge the first conductor 31B into contact with the terminals at the second end of each of the plurality of cells 35A, 35B, . . . 35Z.

The resilient members are fabricated as a unitary body from silicone rubber, which is particularly effective material for use in performing the aforementioned function by extending into depressions corresponding to each of the plural protrusions provided on the first and second conductor plates 31A, 31B, 31C, 31D when a compressive force is applied to the battery pack assembly 3.

The fasteners 32A, 32B, . . . 32Z are reversible, and as such, removal or loosening of the fasteners 32A, 32B, . . . 32Z enables the plurality of cells to be freed from the battery pack assembly 3, when in an opened or disassembled condition.

The resilient members need not be present, for example, as shown in our earlier patent application WO2020128532.

Referring now to FIGS. 2a and 2b, there is shown a battery pack assembly 100 according to a first embodiment of the invention.

The battery pack assembly 100 comprises a first outer holding frame 101a, a second outer holding frame 101b, an intermediate holding frame 101c, a first plurality of cells 102a, and a second plurality of cells 102b. The first plurality of cells 102a is located between the first outer holding frame 101a and the intermediate holding frame 101c, and the second plurality of cells 102b is located between the second outer holding frame 101b and the intermediate holding frame 101c.

As will be appreciated, the cells 102a, 102b are shown as circular cells. Each cell has a first end 102e and a second end 102e′. Terminals 102t and 102t′ are located at each of the first end 102e and the second end 102e′ respectively, as is well known for circular cells and shown in FIG. 5 (which also provides a visual comparison between the well-known 18650 and 21700 cells).

An electrically conductive conductor plate for providing electrical contact to at least two of said plurality of cells 102a, 102b is provided but is not shown. A previously stated the conductor plate is located between the cell (102a, 102b) and the adjacent holding frame to electrically connect the cell terminals 102t, 102t′.

The battery pack assembly 100 further comprises an electrical control unit 103 and a separator plate 104. It is shown that the separator plate 104 is located between the plurality of cells 102a, 102b and the electrical control unit 103. The separator plate 104 comprises cut outs or apertures 104d (three are shown, located at one end of the separator plate 104.

The electrical control unit 103 is configured to control the electrical output of the battery pack assembly 100.

Referring also to FIGS. 2c and 2d, there is shown the battery pack assembly 100 wherein the electrical control unit 103 and the separator plate 104 have been removed.

The first outer holding frame 101a and the second outer holding frame 101b each comprise a peripheral wall, P1, P2 respectively. The peripheral wall P1, P2 extends around the entire periphery of each holding frame 101a, 101b respectively. Each peripheral wall P1, P2 comprises a set of bosses 105a, 105b respectively. In this embodiment, there are four bosses in each set of bosses 105a, 105b but only one is labelled for clarity. Located between the cells 102a, 102b and the respective holding frames 101a, 101c and 101b are collector plates (for example as shown in FIG. 1A-D). Tabs or extensions 131t of the collector plates are shown protruding beyond the cells 102a, 102b.

The electrical control unit 103 is secured to the separator plate 104 via screws 103i (see FIG. 2a, only two screws 103i are indicated but more may be present). The separator plate 104 is secured to the peripheral wall P1 of the first holding frame 101a by a first set of removable fasteners (e.g. screws) 103s1, which extend through apertures 104f in the separator plate 104 and are received within the first set of bosses 105a on the first holding frame 101a, which bosses 105a may be internally threaded for engagement with the fasteners. The separator plate 104 is also secured to the peripheral wall P2 of the second holding frame 101b by a second set of removable fasteners (e.g. screws) 103s2, which extend through apertures 104f in the separator plate 104 and are received within the second set of bosses 105b on the first holding frame 101b, which bosses 105b may be internally threaded for engagement with the fasteners. In this embodiment, there are four removable fasteners in each set 103s1, 103s2 but only one of each set is labelled for clarity. There may be more or fewer removeable fasteners 103s1, s2. The apertures 104f are typically non-threaded cavities.

Advantageously, because the separator plate 104 is secured to the holding frames 101a, 101b it provides structural support to the battery pack assembly 100. The separator plate 104 is able to maintain compression of the plurality of cells 102a, 102b within the holding frames 101a, 101b, 101c, which provides shock and vibration resistance.

Further, securement of the separator plate 104 to the first and second outer holding frames 101a, 101b using the removable fasteners 103s1, 103s2 helps to provide further rigidity and structure to the battery pack assembly 100, thereby making the entire battery pack assembly 100 more robust. This reduces the effects of deformation which may result from shock or vibration. In addition, securement of the separator plate 104 to the first and second outer holding frames 101a, 101b also mitigates the impact of plastic creep over time.

The separator plate 104 is fabricated from a non-electrically conductive material, for example, polypropylene, or from glass filled Nylon, or from coated aluminium wherein the coating is a non-electrically conductive material.

In this embodiment, the separator plate 104 is located in substantially perpendicular relations to the holding frame 102a, 102b, 102c and in parallel relations to the axes of the plurality of cells 102a, 102b.

Advantageously, the presence of a separator plate 104 in a battery pack 100 enables the electrical control unit 103 to be more readily accessed, e.g. for repair, replacement and/or upgrade of components within the battery pack assembly 100, without having to dismantle the plurality of cells 102a, 102b held within the holding frame 101a, 101b.

The location of the separator plate 104 on the holding frames 101a, 101b ensures the provision of an air gap A between the plurality of cells 102a, 102b and the separator plate 104, which can help with regulation of the temperature of the cells during use.

Referring to FIG. 2a, it is shown that the separator plate 104 comprises plural bosses 104b (eight shown although a smaller or larger number may be provided) on an uppermost surface (as shown) 104u for receipt of fasteners such as screws. The plural bosses 104b are outboard bosses. The separator plate 104 further comprises plural bosses 104c (two shown although a smaller or larger number may be provided) for the receipt of fasteners such as screws. The purpose of the plural bosses 104b, 104c will be described below in relation to FIG. 3.

Referring to FIG. 2d, it is shown that the first holding frame 101a comprises two bosses 106a, 106b on a lowermost surface 101l for receipt of fasteners such as screws. The second holding frame 101b also comprises two bosses in the same location for the same purpose, although these are not shown. The purpose of the bosses 106a, 106b will be described below in relation to FIG. 4b.

Referring now to FIG. 3 there is shown a battery 200 according to an embodiment of the invention. The battery 200 comprises a housing H comprising a closure 201, which in this embodiment is a removable lid 201, and a body portion 202. The removable lid 201 comprises a handle 201a. The body portion 202 comprises a base and upstanding walls. The housing H completely encloses the plurality of cells 102a, 102b and holding frames 103a, 103b, 103c of the battery pack assembly 100 of FIG. 2a.

The battery 200 further comprises the electrical control unit 103 and the separator plate 104 of the battery pack assembly 100. The electrical control unit 103 is connected to the cells 102a, 102b (via the exposed extensions or tabs 131t) through the cut-out or apertures 104d in the separator plate 104. The electrical control unit 103 may comprise a battery management system (BMS). The BMS may monitor the voltage across the connector plates to determine the internal resistance of groups of cells and, by so doing, identify groups of cells which may not be operating at optimum capacity. The BMS may be able to issue an alert if cells (or groups thereof) are not operating at optimum capacity (or at least within acceptable operating parameters). Principal electrical connection to the electrical control unit 103 will be achieved via input/output tabs to provide the full power output from the serially connected cells 102a, 102b (or more accurately the serially connected groups of cells).

Terminals T are provided on the closure 201 to facilitate the flow of electricity from the battery 200 and/or the charging of the cells 102a, 102b within the battery 200. The control electronics 103 may comprise various components to ensure that the battery 200 is discharging or charging within acceptable limits, for example voltage, current, temperature. Safety mechanism, such as automatic cut-offs may be provided within the control electronics 103 if the battery is operating outside of tolerable thresholds (for example if the temperature is too hot or cold for optimum charging).

The lid 201 is removably secured to the body portion 202 of the housing H, and to the separator plate 104, by fasteners 203a, 203b, . . . 203z. Only three fasteners are labelled, but in this embodiment the battery 200 comprises ten fasteners. The fasteners 203a, 203b, . . . 203z reversibly secure the lid 201 to the separator plate 104. In this embodiment, the fasteners 203a, 203b, . . . 203z are screws. Fasteners 203a extend through bosses 104c and are relatively long, whereas fasteners 203b extend though bosses 104b and are relatively short.

Advantageously, the provision of removable fasteners 203a, 203b, . . . 203z enables the electrical control unit 103 to be accessed for maintenance and repair without having to disassemble all of the components of the battery 200.

Referring now to FIGS. 4a and 4b, there is shown the battery 200 of FIG. 3. FIG. 4b shows the battery 200 in an exploded condition. The battery 200 comprises the battery pack assembly 100 of FIG. 2a, comprising the first outer holding frame 103a, the second outer holding frame 103b, the intermediate holding frame 103c, the first plurality of cells 102a, and the second plurality of cells 102b. The first plurality of cells 102a is located between the first outer holding frame 103a and the intermediate holding frame 103c, and the second plurality of cells 102b is located between the second outer holding frame 103b and the intermediate holding frame 103c.

In FIG. 4b, it is further shown that the battery 200 comprises a set of removable fasteners 208a, 208b, 208c, 208d. The removable fasteners 208a, 208b, 208c, 208d are configured to secure the body portion 202 to the outer holding frames 103a, 103b.

The removable fasteners 208a and 208c are receivable within two bosses 106a, 106b on the first holding frame 101a (see FIG. 2d) to secure the body portion 202 to the peripheral wall P1 of the first outer holding frame 103a. The removable fasteners 208b, 208d are receivable within two bosses (not shown) on the second holding frame 101b to secure the body portion 202 to the peripheral wall P2 of the second outer holding frame 103b. The removable fasteners

In this embodiment, the housing H has a cuboid shape, and one of the four removable fastening means 208a, 208b, 208c, 208d is located at or near each corner of the body portion 202. In this embodiment, the removable fasteners 208a, 208b, 208c, 208d are removable screws.

Advantageously, the provision of a removable lid 201 enables components of the battery 200, e.g. the electrical control unit 103, to be accessed for repair without having to dismantle the entire battery pack assembly. More advantageously, the housing H functions as a structural member within the battery 200 by maintaining compression of the plurality of cells 102a, 102b within the holding frame 103a, 103b, 103c. This provides shock and vibration resistance without the presence of additional compression points on the holding frame 103a, 103b, 103c.

More advantageously, provision of removable fastening means 208a, 208b, 208c, 208d configured to secure the two outer holding frames 103a, 103b to the body portion 202 enables the user to remove these fastening means 208a, 208b, 208c, 208d to access the plurality of cells 102a, 102b whilst the removable lid 201 is secured to the separator plate 104, which is in turn secured to the first and second outer holding frames 103a, 103b (as shown in FIG. 4a). The handle 201a is used to more easily remove the holding frames 103a, 103b, 103c containing the plurality of cells 102a, 102b from the body portion 202, e.g. for maintenance and repair purposes. Similarly, if access to the control electronics 103 is required, the fasteners 203a, 203b, 203z can be removed to remove closure 201 (as shown in FIG. 4a).

It will be appreciated that the periphery of the separator plate 104 is sandwiched between the closure 201 and the body portion 202, the fasteners 203a, 203b extending therethrough. At least some of the fasteners 203a or 203b may secure the lid to the body portion 202. The separator plate 104 acts to rigidify the structure by providing a brace member across the body portion 202 and further helps to ensure that the walls of the body portion 202 retain their position during use.

It will be appreciated by those skilled in the art that several variations to the aforementioned embodiments are envisaged without departing from the scope of the invention.

It will also be appreciated by those skilled in the art that any number of combinations of the aforementioned features and/or those shown in the appended drawings provide clear advantages over the prior art and are therefore within the scope of the invention described herein.

1.-32. (canceled)

33. A battery pack assembly, the assembly comprising:
a plurality of cells, each cell having a body portion extending between a first end having a first terminal and a second end having a second terminal,
a first holding frame being configured to accommodate at least the first end of one or more of the plurality of cells and
a second holding frame being configured to accommodate at least the second end of one or more of the plurality of cells,
an electrical control unit configured to control the electrical output of the battery pack assembly, and
a separator plate, wherein the separator plate is located between the plurality of cells and the electrical control unit and is secured to the first holding frame and the second holding frame.

34. A battery pack assembly according to claim 33, wherein the separator plate comprises or consists of a non-electrically conductive material which is selected from polyamide, polycarbonate, polyvinyl chloride, polyamide reinforced with fibres, polycarbonate reinforced with fibres, polyvinyl chloride reinforced with fibres.

35. A battery pack assembly according to claim 33, wherein the separator plate is removably secured to the first holding frame and to the second holding frame.

36. A battery pack assembly according to claim 33, wherein the separator plate comprises a first plurality of apertures and/or a second plurality of apertures.

37. A battery pack assembly according to claim 36, comprising fasteners extending through one or more of the first plurality of apertures to engage the first holding frame and/or comprising fasteners extending through one or more of the second plurality of apertures to engage the second holding frame.

38. A battery pack assembly according to claim 33, further comprising an intermediate holding frame which is located between the first holding frame and the second holding frame.

39. A battery pack assembly according to claim 38, wherein a first plurality of said plurality of cells are located between the first holding frame and the intermediate holding frame and/or wherein a second plurality of said plurality of cells are located between the second holding frame and the intermediate holding frame.

40. A battery pack assembly according to any claim 38, wherein the intermediate holding frame is rebated with respect to the first holding frame and the second holding frame so as to define a space between the intermediate holding frame and the separator plate.

41. A battery pack assembly according to claim 33, wherein the separator plate is located in substantially perpendicular relations to the first and second holding frame.

42. A battery pack assembly according to claim 33, wherein each of the first and second holding frame has a base and a peripheral wall bounding the base.

43. A battery pack assembly according to claim 42, wherein the peripheral wall of each of the first holding frame and the second holding frame comprises apertures for the receipt of fasteners for the securement of the separator plate thereto.

44. A battery pack assembly according to claim 42, wherein the separator plate has a periphery, at least a portion of which extends outboard of the base of the first holding frame and/or the base of the second holding frame.

45. A battery pack assembly according to claim 44, comprising outboard apertures extending through the periphery of the separator plate.

46. A battery pack assembly according to claim 45, further comprising a housing, wherein the housing comprises a body portion and a closure.

47. A battery pack assembly according to claim 46, further comprising closure fasteners and wherein at least some of the closure fasteners secure the closure to the separator plate and wherein at least some of the closure fasteners secure the closure to the body portion.

48. A battery pack assembly according to claim 46, wherein the closure comprises terminals for electrically connecting the plurality of cells to an external body.

49. A battery pack assembly according to claim 46, wherein the housing comprises housing apertures for the receipt of housing fasteners to secure the housing to one or both of the first holding frame and the second holding frame.

50. A battery pack assembly according to claim 33, wherein the electrical control unit is located adjacent the separator plate, and/or the separator plate is located adjacent the holding frame.

51. A battery pack assembly according to claim 50, wherein the electrical control unit is removably secured to the separator plate.

52. A battery pack assembly according to claim 33, wherein the electrical control unit is electrically connected to at least some of the plurality of cells via an aperture located in the separator plate.
